(19) United States
(12) Patent Application Publication
(10) Pub. No.: US 2025/0061351 A1
(43) Pub. Date: Feb. 20, 2025

(54) FOUNDATION MODEL FROM ASYNCHRONOUS EVENTS SEQUENCES

(71) Applicant: U.S. Bank National Association, Minneapolis, MN (US)

(72) Inventor: Giacomo Domeniconi, Queens, NY (US)

(73) Assignee: U.S. Bank National Association, Minneapolis, MN (US)

(21) Appl. No.: 18/449,257

(22) Filed: Aug. 14, 2023

(51) Int. Cl. G06N 5/022

(52) U.S. Cl. CPC G06N 5/022

(57) ABSTRACT

Methods, systems, and computer program products are provided for training a transactional event data analysis model and fine-tuning a pre-trained model to predict future transactions. The method involves storing asynchronous event sequence data of a user in a transaction table, selecting a user transaction at a snapshot time, selecting transactional events made by user U before time, and storing them in a transactions table. The method further includes mapping the timing position of each transactional event in the transactions table using, e.g., an integer index or a one-hot encoded vector. Features are selected and encoded into token encodings and time encodings.

### FIELD

The example embodiments described herein relate generally to machine learning, and more particularly to generating foundation models based on asynchronous events sequences.

### BACKGROUND

A foundation model is a type of deep learning model that serves as a starting point or a “foundation” for building more specialized or complex models. It is usually pre-trained on a large dataset and can be fine-tuned on a smaller dataset for a specific task. Well-known foundation models include large language models such as BERT (Bidirectional Encoder Representations from Transformers), GPT (Generative Pre-training Transformer), and T5 (Text-to-Text Transfer Transformer). Large language models have found applications in diverse areas, including language understanding, sentiment analysis, named entity recognition (NER), question answering, text classification, text summarization, and the development of conversational agents like chatbots and virtual assistants.

Large language models such as BERT and GPT rely on a type of neural network layer, called a transformer. A transformer architecture includes an encoder and decoder, each consisting of multiple layers of self-attention and feedforward neural networks. Self-attention is a mechanism that allows the model to focus on different parts of the input sequence and capture the relationship between them.

In the context of natural language processing, a foundation model refers to a large pre-trained neural network model that has been trained on a massive amount of text data to learn the underlying patterns and structures of natural language. These models are designed to capture a wide range of linguistic information, including syntax, semantics, and pragmatics, and can be fine-tuned on specific natural language processing tasks such as text classification, sentiment analysis, and machine translation. By pre-training a large neural network on a massive amount of text data, foundation models can learn to generate high-quality representations of natural language, which can be fine-tuned on smaller, task-specific datasets with limited labeled data. This approach is known as transfer learning and has become a popular technique in natural language processing in recent years.

Currently, the use of large language models in the field of natural language processing is advancing rapidly, and numerous applications have already been established in areas such as language understanding, sentiment analysis, named entity recognition (NER), question answering, text classification, text summarization, and conversational agents like chatbots and virtual assistants. However, the deployment of large language models in specific industries like customer service, healthcare, and finance is still relatively limited. One challenge is that the data used in natural language processing may differ in format from other types of data commonly used in these industries.

Transactional event data, for example, is classified as asynchronous events sequences data because the events are not necessarily occurring at regular time intervals. In a traditional time series, the data points are recorded at regular time intervals, such as every second, minute, hour, or day. However, in the case of transactional data, events can occur at irregular intervals, such as when a customer makes a purchase. These events may not have a fixed time interval between them, and their occurrence is often unpredictable.

Moreover, transactional events can occur simultaneously, or one event may trigger another event, leading to a complex, non-linear relationship between events. This makes it challenging to represent the data as a fixed-length sequence of tokens or to apply traditional time series analysis techniques.

There is a need, therefore, for novel solutions that can build a foundation model with asynchronous events sequences data such as transactional event data.

### SUMMARY

The example embodiments described herein meet the above-identified needs by providing methods, systems and computer program products for training a transactional event data analysis model and fine-tuning a pre-trained model for predicting future transactions. One example embodiment involves a method for training a transactional event data analysis model. The method comprises storing transactional event data of a user U in a transaction table, where transactional event data is asynchronous events sequences data (e.g., the events are not necessarily occurring at regular time intervals); randomly selecting a user U transaction from the transaction table at a random snapshot time T; selecting N transactional events made by user U before the random snapshot time T and storing the N transactional events in an N-transactions table; and mapping a transactional event timing position of each of the N transactional events stored in the N-transactions table, where the transactional event timing position is represented using an integer index or a one-hot encoded vector.

The N transactional events, in some examples, are selected by any one of (i) defining a maximum number N of collected transactional events, (ii) defining a number N based on a maximum backward time T-Δ during which transactional events were collected, or (iii) a combination of (i) and (ii).

In some embodiments, the method further involves selecting a plurality of features of a plurality of transactional events stored in the N-transactions table and feature encoding each feature. The feature encoding includes encoding each feature into a one-hot vector, and encoding each feature into a token vector. This embodiment further involves concatenating the one-hot vector and the token vector for each feature, thereby generating concatenations of the one-hot vector and the token vector to form a token encoding vector; generating a time encoding vector by computing the time passed since the snapshot time T and the actual time of the transactional event; and providing the token encoding vector and the time encoding vector as an input sequence into a transactional model.

In some embodiments, the method further comprises selecting (e.g., randomly) one or more transactional events to be masked in the input sequence to a transactional model; masking the selected transactional events, wherein masking is applied to either (i) the entire token encodings, or (ii) a portion of the token encodings, thereby producing masked transactional events; training the transactional model to decode and reconstruct the original input sequence using unmasked transactional events as context; predicting the masked transactional events based on the context provided by the unmasked transactional events; and training the transactional model to learn underlying patterns and dependencies in the input data.

The method, in further embodiments, further comprises receiving two transactional event sequences; training the transactional model to predict a next transactional event sequence using a predictive modeling algorithm for pre-training to learn patterns and dependencies based on the two transactional event sequences; performing a masking training stage by randomly masking one or more transactional events in the two transactional event sequences and training the transactional model to predict the masked transactional events based on the unmasked transactional events in the two transactional events sequences; and adding an additional output layer to the transactional model to classify query input sequences as belonging to the same users corresponding to the two transactional event sequences of different users.

In an example implementation, the method comprises retrieving transactional events from the N-transactions table, wherein each of the transactional events contains F categorical features, where each feature is represented by a sub-vocabulary of Fn possible tokens; encoding each categorical feature as a binary vector using a one-hot encoding scheme, where the binary vector has a length equal to the number of possible tokens in the sub-vocabulary; concatenating the binary vectors of each categorical feature to form a multi-hot vector for the transaction, where the size of the multi-hot vector is equal to the sum of the lengths of the binary vectors; and inputting the multi-hot vector as a transactional event data input to a transactional model for analysis.

In some embodiments, the method further comprises quantizing numerical features of a transactional event obtained from the transactional table into a fixed number of bins, where each bin corresponds to a range of values, and each numerical value is assigned to one of the bins based on its magnitude; representing the quantized numerical features using one-hot vectors, where each vector has a size of n_{b}, which is the number of bins assigned to the numerical values after quantization; concatenating the one-hot vectors of the quantized numerical features with the one-hot vectors of any categorical features to form multi-hot vectors; and using the multi-hot vectors as input to the transactional model for training and/or prediction.

In an example implementation, the method involves generating multi-hot vectors using a one-hot encoding scheme for categorical features of each transaction event obtained from the N-transactions table, wherein each categorical feature is represented as a binary vector having a length equal to the number of possible categories, and the binary vector is concatenated with other binary vectors to form each multi-hot vector; representing numerical features of each transactional event using a one-hot encoding scheme, wherein each numerical feature is quantized into n_{b} bins and represented as a binary vector having a length equal to n_{b}, and the binary vector is concatenated with other binary vectors to form each multi-hot vector; mapping a transactional event timing position of each transactional event within a sequence of transactional events by mapping a transaction identifier to a corresponding transactional event timing position of the transaction within the sequence of transactions; and inputting the generated multi-hot vectors and time encodings into a transactional model to generate a transactional model output.

In another example implementation, the method further involves selecting a random set of transactional events that occurred at or before time T from the sequence of transactional events; and generating time encodings for each selected transactional event based on their distance in time of occurrence relative to time T.

In another aspect, there is provided a method for fine-tuning a pre-trained model for predicting future transactions. The method comprises: selecting two sequences of N transactional events for a snapshot time T, wherein the N transactional events are real transaction events executed by a user prior to snapshot time T and M transactional events are M predicted transactional events executed after snapshot time T that are to be predicted; using the selected two sequences of N transactional events as input to a transactional model; training the transactional model to predict the M predicted transactional events given the two sequences of N transactional events as input; applying the two sequences of N transactional events and the M predicted transactional events to a loss computer that computes a loss of the difference between the M predicted transactional events and the two sequences of N transactional events; and training the transactional model by applying the loss to a backpropagation algorithm.

Another example embodiment described herein involves a system for training a transactional event data analysis model. The system comprises, a data store, a transaction selector and a mapper. The data store is configured to store transactional event data of a user U in a transaction table, where transactional event data is asynchronous events sequences data (e.g., the events are not necessarily occurring at regular time intervals). The transaction selector is configured to: randomly select a user U transaction from the transaction table at a random snapshot time T, and select N transactional events made by user U before the random snapshot time T and store the N transactional events in an N-transactions table. The mapper is configured to map a transactional event timing position of each of the N transactional events stored in the N-transactions table, where the transactional event timing position is represented using an integer index or a one-hot encoded vector.

In some embodiments, the transaction selector is further configured to: select N transactional events by any one of (i) defining a maximum number N of collected transactional events, (ii) defining a number N based on a maximum backward time T-Δ during which transactional events were collected, or (iii) a combination of (i) and (ii).

In some embodiments, the system further comprises a feature selector, a feature encoder, a concatenator, a time encoder, and a token encoder. The feature selector is configured to select a plurality of features of a plurality of transactional events stored in the N-transactions table. The feature encoder is configured to: encode each feature into a one-hot vector, and encode each feature into a token vector. The concatenator is configured to concatenate the one-hot vector and the token vector for each feature and generate concatenations of the one-hot vector and the token vector to form a token encoding vector. The time encoder is configured to generate a time encoding vector by computing the time passed since the snapshot time T and the actual time of the transactional event. The token encoder is configured to provide the token encoding vector and the time encoding vector as an input sequence into a transactional model.

In some embodiments, the transaction selector is further configured to select (e.g., randomly) one or more transactional events to be masked in the input sequence to a transactional model. The system also comprises a masking component configured to mask the selected transactional events by masking either (i) the entire token encodings, or (ii) a portion of the token encodings and produce masked transactional events. In this embodiment, the system also comprise a transactional model training and prediction system configured to: train the transactional model to decode and reconstruct the original input sequence using unmasked transactional events as context, predict the masked transactional events based on the context provided by the unmasked transactional events, and train the transactional model to learn underlying patterns and dependencies in the input data.

In some embodiments, the system comprises a transactional model training and prediction system configured to: receive two transactional event sequences, train the transactional model to predict a next transactional event sequence using a predictive modeling algorithm for pre-training to learn patterns and dependencies based on the two transactional event sequences. In this embodiment, the masking component is further configured to randomly mask one or more transactional events in the two transactional event sequences and train the transactional model to predict the masked transactional events based on the unmasked transactional events in the two transactional events sequences; and the transactional model training and prediction system is further configured to add an additional output layer to the transactional model to classify query input sequences as belonging to the same users corresponding to the two transactional event sequences of different users.

In an example implementation, the transaction selector further configured to retrieve transactional events from the N-transactions table, wherein each of the transactional events contains F categorical features, where each feature is represented by a sub-vocabulary of Fn possible tokens. In this implementation, the system further comprises a feature encoder configured to encode each categorical feature as a binary vector using a one-hot encoding scheme, where the binary vector has a length equal to the number of possible tokens in the sub-vocabulary; a concatenator configured to concatenate the binary vectors of each categorical feature to form a multi-hot vector for the transaction, where the size of the multi-hot vector is equal to the sum of the lengths of the binary vectors; and a data analyzer configured to input the multi-hot vector as a transactional event data input to a transactional model and perform data analysis on the transactional event data.

In some embodiments, the system further includes a quantizer configured to: quantize numerical features of a transactional event obtained from the transactional table into a fixed number of bins, where each bin corresponds to a range of values, and each numerical value is assigned to one of the bins based on its magnitude; represent the quantized numerical features using one-hot vectors, where each vector has a size of n_{b}, which is the number of bins assigned to the numerical values after quantization. In this embodiment, the system further includes a concatenator configured to concatenate the one-hot vectors of the quantized numerical features with the one-hot vectors of any categorical features to form multi-hot vectors; and a transactional model training and prediction system configured to apply the multi-hot vectors as input to the transactional model for training and/or prediction.

In an example implementation, the system further comprises: a feature encoder configured to: generate multi-hot vectors using a one-hot encoding scheme for categorical features of each transaction event obtained from the N-transactions table, wherein each categorical feature is represented as a binary vector having a length equal to the number of possible categories, and the binary vector is concatenated with other binary vectors to form each multi-hot vector, and represent numerical features of each transactional event using a one-hot encoding scheme, wherein each numerical feature is quantized into no bins and represented as a binary vector having a length equal to n_{b}, and the binary vector is concatenated with other binary vectors to form each multi-hot vector. The mapper further configured to map a transactional event timing position of each transactional event within a sequence of transactional events by mapping a transaction identifier to a corresponding transactional event timing position of the transaction within the sequence of transactions. In this embodiment, the system further comprises a transactional model training and prediction system configured to apply the generated multi-hot vectors and time encodings into a transactional model to generate a transactional model output.

In an example implementation, the transaction selector further configured to select a random set of transactional events that occurred at or before time T from the sequence of transactional events; and the feature encoder further configured to generate time encodings for each selected transactional event based on their distance in time of occurrence relative to time T.

In another embodiment described herein, a system for fine-tuning a pre-trained model for predicting future transactions is provided. The system includes a sequence selector configured to select two sequences of N transactional events for a snapshot time T, wherein the N transactional events are real transaction events executed by a user prior to snapshot time T and M transactional events are M predicted transactional events executed after snapshot time T that are to be predicted; a transactional model training and prediction system configured to: apply the selected two sequences of N transactional events as input to a transactional model, train the transactional model to predict the M predicted transactional events given the two sequences of N transactional events as input, apply the two sequences of N transactional events and the M predicted transactional events to a loss computer that computes a loss of the difference between the M predicted transactional events and the two sequences of N transactional events, and train the transactional model by applying the loss to a backpropagation algorithm.

In another embodiment described herein, there is provided a non-transitory computer-readable medium having stored thereon sequences of instructions, the sequences of instructions including instructions which when executed by a computer system causes the computer system to perform the methods described herein.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates a transactional model training architecture for pre-training and fine-tuning a transactional model, according to an example embodiment.

FIG. 2 illustrates a data flow for preparing transactional event data input for a transactional model, according to an example embodiment.

FIG. 3 illustrates an input encoder for encoding each of a plurality of transactional events using token encoding and time encoding, according to an example embodiment.

FIG. 4 illustrates a self-supervised architecture for pre-training a transactional model using masking, according to an example embodiment.

FIG. 5 illustrates a self-supervised architecture for pre-training a transactional model that combines masked transaction modeling and next sequence prediction, according to an example embodiment.

FIG. 6 illustrates a self-supervised architecture for pre-training a transactional model, according to an example embodiment.

FIG. 7 illustrates a fine-tuning architecture for fine-tuning a transactional model, according to an example embodiment.

FIG. 8 is a block diagram of a computing system that can be used to implement aspects herein, such as for training a transactional event data analysis model and fine-tuning a pre-trained model for predicting future transactions.

### DETAILED DESCRIPTION

Transactional event data differs from natural language processing data in their underlying characteristics and the challenges associated with processing them. In natural language processing tasks, the input to the transformer is typically a sequence of tokens along with their respective positions, such as words or subwords. Each token is first embedded into a vector representation, and then fed into the transformer encoder layer. The output of the encoder is then used by the decoder layer to generate the final output sequence. When it comes to transaction-type events, however, typical transformer architectures are not effective because transactional data involves asynchronous events sequences that are highly dimensional structured data, with multiple subfields (e.g., amount, time, merchant category, location, and the like) making it challenging to represent the data using a fixed sequence of tokens. In other words, while transformer architectures are good at handling text related data, traditional transformer architectures do not effectively handle asynchronous events sequences, such as transactional event data.

### Transactional Model Architecture

Examples disclosed herein include models that address the challenges in handling transaction event data and event sequences. For instance, there are methods, systems and computer program products for generating foundation models in contexts involving data of asynchronous event sequences, which are now described herein in terms of transactional event data (e.g., credit card usage, user purchases, and other interactions between parties). This description is not intended to limit the application of the example embodiments presented herein. In fact, after reading the following description, it will be apparent to one skilled in the relevant art(s) how to implement the following example embodiments in alternative embodiments that involve asynchronous events sequences data in other areas (e.g., processing sensor data or client-server communication).

### Input Preparation

One aspect of the embodiments described herein involves preparing transactional event data for input into a transactional model. In an example implementation, the transactional model is based on attention-based layers, such as transformer layers or other neural network architectures that accept a sequence as input, such as recurrent neural networks like gated recurrent unit) or LSTM (Long Short-Term Memory). Another aspect of the embodiments described herein involves architectures that optimize input preparation of transactional data for the transactional model.

In some embodiments, transactional event data is encoded into feature vectors (also known as embeddings) for downstream tasks, such as for input to the transactional model. Examples of encodings that can be used to represent the transactional event data as feature vectors include: token encodings, time encodings, and segment encodings.

### Token Encoding

A token encoding can be an encoding generated as or by a multi-hot vector. A multi-hot vector is a type of binary vector that is used to represent categorical data using binary values (0s and 1s). It is generated by assigning a unique index or position to each possible category and setting the corresponding index or position in the vector to 1 if the transactional event belongs to that category, and 0 otherwise. In this way, the categorical features are encoded numerically. Encoding categorical features numerically typically involves converting each unique category or value of a categorical feature into a numerical value or representation.

In examples, to generate a multi-hot vector for a transactional event, each categorical feature of the transactional event is first represented as a numerical variable, referred to more particularly as a categorical variable. A categorical feature is a type of variable that can take on a limited number of discrete values, representing a specific attribute or characteristic of the data. For example, in the case of transactions, some of the categorical features might include: a merchant category (e.g., restaurant, gas station, etc.), product category (e.g. electronics, books, clothing, etc.), payment method (e.g. credit card, PAYPAL, Bitcoin, etc.), shipping destination (e.g. United States, Canada, Europe, etc.), zip code of the transaction. Other categories or information can be used as relevant.

Numerical features, such as a transaction amount, can be represented with a fixed number of bins. Each numerical value is assigned to one of the bins based on its magnitude, with each bin corresponding to a range of values. In some embodiments, numerical features are represented with 1 value or represented with quantized bins of size n_{b}. As such, the one-hot vector representing the numerical feature has a size of n_{b}, where n_{b} is the number of bins assigned to the numerical values after quantization. In some embodiments, the one-hot vector has a size of n_{b}, where n_{b}=Fₙ. In some embodiments, the one-hot vector has a size of n_{b} that is different from Fₙ.

Each categorical feature is then encoded using a one-hot encoding scheme, where a binary vector having a length equal to the number of possible categories is used to represent each corresponding categorical variable. In other words, categorical features can be represented as one-hot encoded values. For example, if there are five possible product categories, a binary vector of length five is used to represent the product category feature. If, for instance, a product belongs to the third category, its feature vector would be [0, 0, 1, 0, 0].

Finally, the binary vectors for each categorical variable are concatenated together to form the multi-hot vector for the transaction. The resulting vector has a length equal to the total number of possible categories across all the features, with a value of 1 at each index corresponding to a category that is present in the transaction, and 0 otherwise.

Given F features for a transaction (e.g., selected variables or selected columns of a database table), each feature can be represented as a one-hot vector, created by a sub-vocabulary of Fₙ possible tokens. As such, the vector may have a size of Fₙ.

Once the categorical features have been encoded numerically, they can be used as input to the transactional model for training or prediction. The numerical encoding allows the machine learning algorithm of the transactional model to understand and operate on the categorical feature as a numerical variable, even if the original variable was categorical.

Other features of the transactional events may be numerical. For example, in the case of commerce transactions, some of the features might include a purchase amount, a time passed within the start of the session to purchase, a number of items purchased, a shipping cost, or any other features with corresponding numerical attributes. In some embodiments, the values of the numerical features are scaled and/or normalized and used directly as input to the transactional model for training or prediction.

The token encodings multi-hot vector may be generated by the concatenation of each sub-vector of each feature, having a size of the union of the Fₙ sub-vocabularies. That is, the token encodings multi-hot vector, in some embodiments, is generated by concatenating the one-hot encoded sub-vectors for each feature. Each feature has its own sub-vocabulary of possible tokens, and the size of each sub-vector is equal to the size of the corresponding sub-vocabulary. The resulting multi-hot vector has a size equal to the sum of the sizes of all sub-vocabularies, which represents the union of all possible tokens across all features. The values in the multi-hot vector indicate which tokens are present in the transaction, with a value of 1 indicating the presence of a token and a value of 0 indicating the absence of a token.

In some examples, vectors are fed into an embedding layer, that generates a continuous embedding vector in a lower-dimensional space. The purpose of using the embedding layer is to reduce the input space and to provide a representation into a continuous and dense space where similar features are close to each other. The embeddings of all the categorical features are then concatenated together to form the input of the transactional model.

In other embodiments, the token encodings may be generated by a neural network, such as a transformer-based approach like tabular Transformer or GatedTabTransformer. This neural network is trained to ingest features of an event and produces a latent representation vector of these event features as output. In this embodiment, the latent representation vector, which captures the essential information and relationships among the event features, serves as the token encoding for the event. This latent representation is, in turn, used as input to a transactional model for further processing, training and prediction tasks. Using a transformer-based approach like tabular transformer or GatedTabTransformer allows for the efficient extraction of meaningful patterns and dependencies within the event's features, making the resulting token encodings more informative and effective for subsequent tasks handled by the transactional model. This integration of transformer-based techniques with the transactional model enhances the model's ability to understand and process the data, leading to improved performance in various applications such as data analysis, sentiment analysis, prediction analysis, and the like.

### Time Encoding

In some embodiments, time encodings are used to refer to the time of each transaction within a sequence of transactions. A time of a transaction within a sequence of transactions is referred to herein as a timing position. A transactional event timing position can be represented in different ways. In an example integer index implementation, a lookup table is created to provide the timing of the transaction within the sequence of transactions. In such embodiments, each transaction in the sequence of transactions is assigned a unique timing identifier, such as a timestamp or a sequential index, that provides a transactional event timing position within a sequence of transactions. The lookup table is then used to map each timing identifier to its corresponding transactional event timing position within the sequence of transactions.

For example, suppose a sequence of 5 transaction events is provided, each with a unique timestamp identifier. A lookup table can be generated that maps each timestamp to its corresponding transactional event timing position in the sequence:

Example Lookup Table

| Timestamp | Timing Position |
|---|---|
| 1630000000 | 1 |
| 1631000000 | 2 |
| 1632000000 | 3 |
| 1633000000 | 4 |
| 1634000000 | 5 |

Then, during training or inference, each transactional event is represented using a vector of features, such as the transaction amount and product category, as well as a time encoding vector obtained from the lookup table using the transaction timestamp. For a transaction having a timestamp of 1633000000, the timing position can be determined and understood to be 4.

In some embodiments, the transactional event timing position is represented as a one-hot encoded vector, where each event's timing information is represented as a binary vector. The vector's length is equal to the total number of events or time intervals considered in the sequence. For each event in the sequence, only one element of the vector is set to 1 (hot), while all other elements are set to 0 (cold). The position of the hot element in the vector corresponds to the specific event's timing position. Using a one-hot encoded vector allows for explicit representation of the relative timing of events and provides relatively more fine-grained information about the temporal relationships between events.

In some embodiments, the timing of a transaction within a sequence may refer to the distance in time of its occurrence relative to a particular instance in time T, expressed in days, weeks, seconds, or any other appropriate unit of time. In other words, the timing of a transaction within a sequence can be defined as the distance in time between the transaction's occurrence and a specific instance in time T. In such embodiments, the input to the transactional model may include a selection of transactions that occurred at or before time T, rather than the entire sequence of transactions. In some embodiments the selection is random.

To incorporate the timing information of each transaction, a time encoding is added to each token encoding in the sequence. The time encoding may refer to the distance in time between each transaction and the instance in time T, expressed in days, weeks, seconds, or any other appropriate unit of time. This can be represented as a vector or scalar value that is added to each token encoding to create the final input to the model.

In some embodiments, a sequence of the last N transactions made by the customer before time T is selected. In turn, token encodings are created for each transaction. A time encoding is, in turn, added to each token encoding, representing the number of days, weeks, seconds, or any other appropriate unit of time, between each transaction and time T.

A time encoder may use the date of a transaction, for instance, with a timestamp of the transaction.

Additional functions such as sine, cosine, exponentials, etc., can be applied to the time encoding to introduce relative positional information in the sequence data. These functions enhance the representation of time-related patterns and relationships within the data, introducing relative positional information in the sequence data. In some examples, noise can be added to the time encoding to add an additional layer of privacy.

### Segment Encoding

In some embodiments, segment encoding is employed to encode information about a sequence to which a transaction belongs. In a next sequence prediction use-case, a transactional model is used to predict the next sequence of transactions based on the existing sequences. In an example implementation involving next sequence prediction use-cases, the transactional model may take in one or more pairs of sequences. Each transaction can be assigned to a specific sequence, and segment encoding is used to encode this information.

The segment encoding can be as simple as a binary value where zero indicates one sequence and one indicates another sequence. Alternatively, segment encoding can be represented using a one-hot encoded vector with a length equal to the number of sequences. The segment encoding provides information about the sequence membership of each transaction in situations involving multiple sequences in the transactional model.

### Event Time Series Input

In some embodiments, an input sequence of a transactional model involving transactional event data can be or include an event time series. An event time series is a type of time series data where events are recorded based on their occurrence time, and the values are associated with those events. For example, a company might record the time and value of each purchase made by a customer.

In an event time series, each transaction can be considered independently. In some embodiments, when the input sequence of the model is a time series input, transactions made within a certain time interval (such as each day, week, or month) are aggregated into a single vector. This aggregated vector is then used to generate token encodings. The process of aggregation may include additional steps to define how the aggregation is done and what features are included in the aggregated vector. The actual aggregated vector used to generate the token encodings can be defined. In some embodiments, multiple aggregation features can be used per each feature. For example, the average and the standard deviation of a feature can be computed to aggregate the events occurring in each time interval.

In some embodiments, the input sequence of the transactional model may be a synchronous time series input. A synchronous time series input refers to a type of time series data where events or observations are recorded at fixed and regular time intervals. In other words, the time intervals between each observation in the time series are consistent and follow a predefined schedule.

In some embodiments, the input sequence of the transactional model may be an asynchronous time series input. Asynchronous events sequences input is a type of time series data where the time intervals between observations are irregular and not fixed.

Whether the input sequence involves synchronous event time series or asynchronous events sequences, the transactional model is used to analyze each transaction separately, without considering any relationships or dependencies between them. Each transaction can thus, in some embodiments, be evaluated in isolation.

### Training Architecture for Pre-Training and Fine-Tuning a Transactional Model

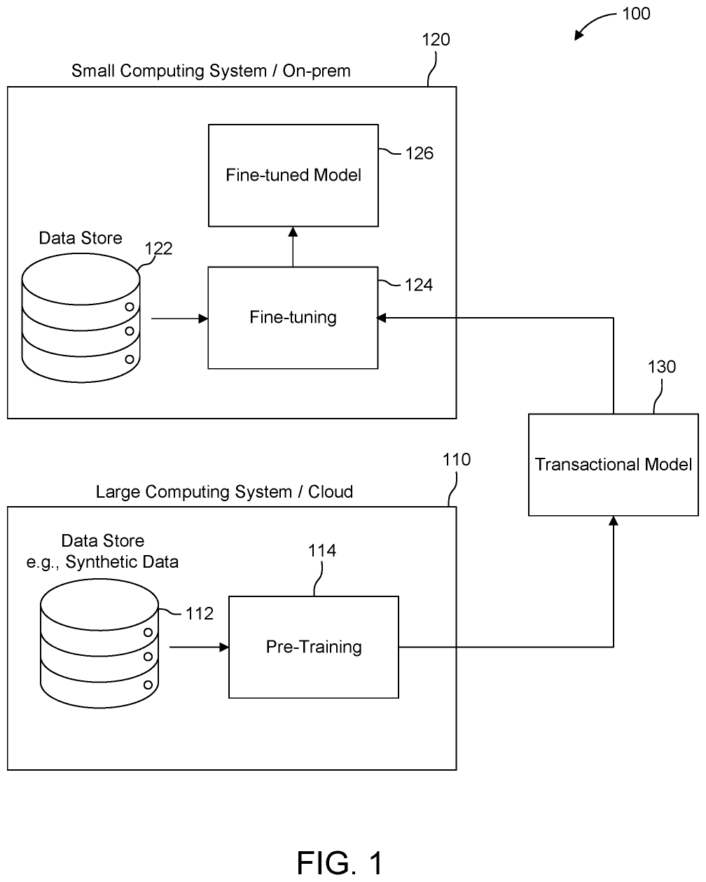

FIG. 1 illustrates a transactional model training architecture 100 for pre-training and fine-tuning a transactional model, according to an example embodiment. In some embodiments, transactional model training architecture 100 includes a large computing system 110 and a small computing system 120. A transactional model 130 is pre-trained on the large computing system 110 (e.g., on the cloud or large hardware environment). The transactional model 130 is, in turn, deployed on the small computing system 120 (e.g., on-prem computing system or private cloud) to fine-tune the pre-trained transactional model.

The large computing system 110 is a system that includes a set of interconnected computers or servers that cooperate to perform a wide range of computing tasks. These systems are typically used to handle large volumes of data, process complex algorithms, and support high-performance computing applications that require significant processing power, memory, and storage capacity. The large computing system 110 can be deployed in a variety of configurations, ranging from a cluster of servers located in a single data center to a distributed network of servers located across multiple geographic regions. They may be composed of a mix of different types of hardware and software, including specialized processors, storage arrays, and network interconnects. Example large computing systems 110 include high-performance computing clusters, cloud computing platforms used by businesses and organizations to host and manage their applications and data, and supercomputers used for complex simulations and data analysis.

The large computing system 110 can include or be communicatively coupled to one or more data stores 112. The data store 112 can be a collection of data that is stored in or for the large computing system 110 and can be accessed and managed by authorized users or applications. The data store 112 may contain a wide range of data, such as financial transactions, customer data, other data, or combinations thereof. To manage a large volume of data, the data store 112 can be configured as a database and use specialized software and hardware, such as database management systems and distributed computing systems.

The small computing system 120 herein can be a system that includes a single computer or a few interconnected computers or devices that perform relatively simple computing tasks compared to the large computing system. These systems are typically used for personal or small-scale business use. Small computing systems can include desktop or laptop computers, tablets, smartphones, or other mobile devices, as well as small-scale servers or network devices such as routers or switches. They are generally designed to be energy-efficient compared with large computing systems, with modest processing power, memory, and storage capacity. While small computing systems may not have the same level of performance or scalability as large computing systems, they can still be highly useful for a wide range of applications.

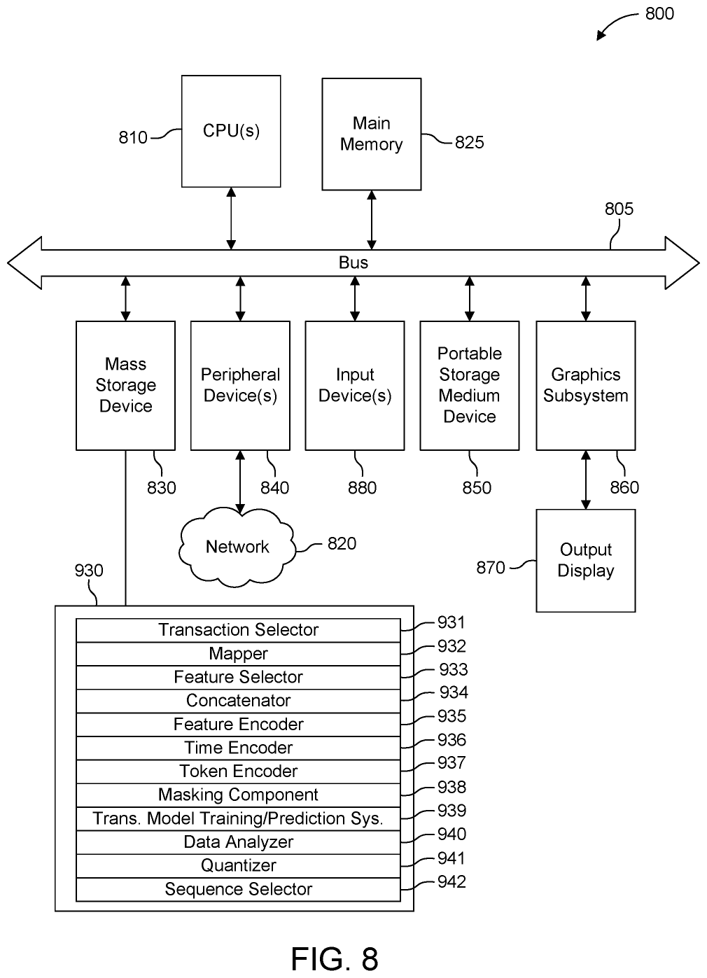

The large computing system 110 and the small computing system 120 can be implemented using one or more components described herein in relation to the system 800 described below in relation to FIG. 8.

In an example embodiment, transactional model 130 is pre-trained by a pre-training process 114. In an example, the training process is unsupervised, which allows training without the need of labeled data. The transactional model 130 may be pre-trained on real-world data, synthetic data, or combinations thereof.

Real-world data generally refers to data that is generated or obtained from a process occurring in the “real-world” independent of the machine learning or training process. Thus, the real-world data can represent a genuine data source. As an example, real-world transaction data from a store can be based on the actual records of the store from genuine transactions (e.g., real people physically or virtually purchasing goods or services) for a primary purpose other than training a machine learning model. Where real-world data is used, it can be used according to a well-defined privacy policy.

Synthetic data generally refers to artificial data that is generated (e.g., using statistical or machine learning) to mimic statistical properties of real-world data. Synthetic data can be used for a variety of purposes, such as testing or training machine learning models, generating realistic scenarios for simulation or gaming, or protecting sensitive data (e.g., data containing personal information) by replacing at least some of the sensitive data with synthetic data that retains the statistical properties of the original data but does not reveal sensitive information. Synthetic data can be generated using a variety of techniques, such as generative adversarial networks, variational autoencoders, generative artificial intelligence models, rule-based models, manual creation, other techniques, or combinations thereof. The synthetic data can then be stored in the same database as the real-world data or in a separate database, depending on the application and data management requirements. The synthetic data can be labeled and identified as synthetic to avoid confusion or misinterpretation of the data by users or applications.

Generally, pre-training process 114 trains the transactional model 130 using a dataset stored in a data store 112 (e.g., a database). Predictions or decisions based on patterns and relationships in the data fed from data store 112 is applied to the pre-training process 114.

Once the transactional model 130 is pre-trained, it is deployed on the small computing system 120. The small computing system 120 is typically an on-premises computing system or a private cloud environment. The reason for deploying on a smaller system is to fine-tune the pre-trained model for specific tasks or domains.

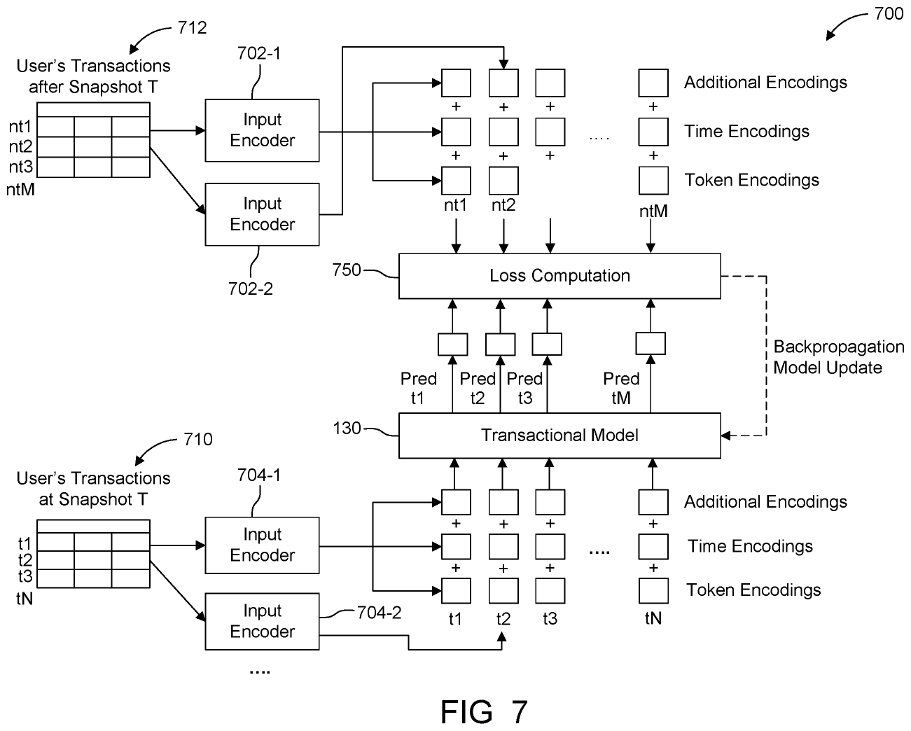

Fine-tuning, generally, is the process of further training the pre-trained transactional model 130 on specific datasets or tasks to adapt it to a target domain. Pre-training can refer to an initial process of training a model on a dataset (e.g., with self-supervised methodologies) before fine-tuning the model for a specific task. In some embodiments, small computing system 120 performs a fine-tuning process 124 using a dataset stored in a data store 122 (e.g., a database or another way of storing relevant data) that is relevant to the specific application or use case. The dataset that is stored in data store 122 is used for the fine-tuning process 124, in some implementations, is relatively smaller and more specialized than the dataset stored in the data store 112 used during pre-training. As a result of the fine-tuning process 124, a fine-tuned model 126 is generated. This fine-tuned model 126 retains the knowledge learned during the pre-training phase but has been adapted to perform better on specific tasks or in the target domain. An example fine-tuning process is described in relation to FIG. 7, below. The fine-tuned model 126 can then be used locally in production to provide useful output given particular input.

While FIG. 1 illustrates the pre-training process 114 and fine-tuning process 124 occurring on large computing system 110 and small computing system 120, respectively, other arrangements can be used. For instance, the large computing system 110 can perform both pre-training process 114 and fine-tuning process 124 (which may remain as separate steps or be combined). The resulting fine-tuned model 126 can be provided to the small computing system 120 for local use or the fine-tuned model 126 can remain on the large computing system 110 and be used in production.

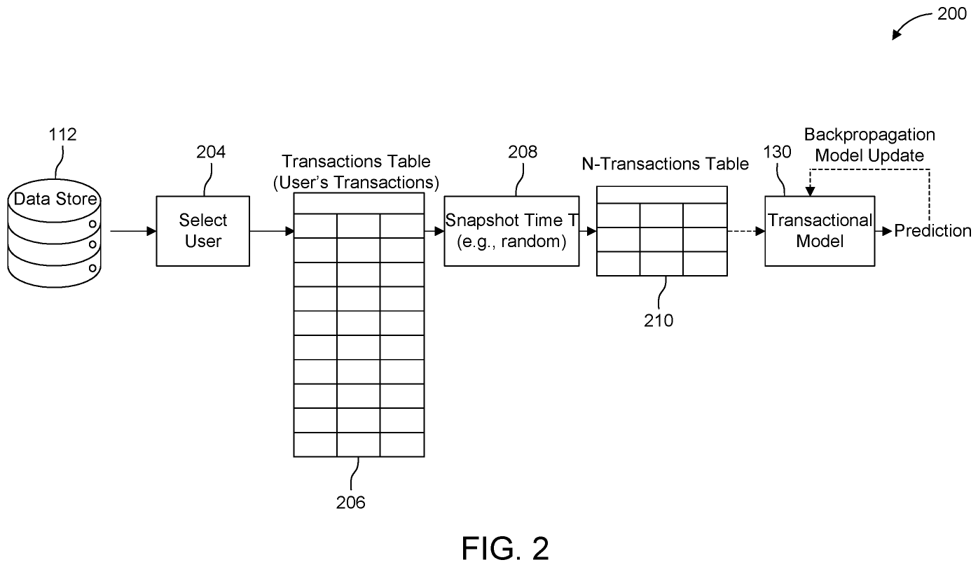

FIG. 2 illustrates a data flow 200 for preparing transactional event data input for a transactional model, according to an example embodiment. In this example embodiment, the input preparation is performed by a time encoding operation that refers to the transactional event timing positions of each transaction within a sequence of transactions.

To begin, a random user U selection operation 204 performs selecting a user U from a plurality of users for whom transactional event data is stored in data store 112. In an example, the user U is selected at random. The transactional event data of the selected user U is, in turn, stored in a transactions table 206, which corresponds to that specific user. Alternatively, this process can be performed virtually, without the need for physically storing the transactions table 206. “Physically storing” in this context refers to the act of saving or recording data in a tangible form on a physical storage medium or device. When data is physically stored, it means that the information is written to and stored on hardware components such as hard disk drives, solid-state drives, magnetic tapes, optical discs, or any other tangible storage medium.

For example, instead of creating individual persistent transaction tables for each user, the system, in some embodiments, performs a table creation operation by creating and using tables in a “virtual” manner, for example by using temporary data structures to handle the data for each user. Storing the transaction tables virtually using this approach can save storage space and computational resources because it avoids the need to create and maintain numerous physical tables in physical storage. In an example implementation, transactional data corresponding to transactions for several users are stored in one table, without the need to create additional tables for each user.

The data from the transactions table 206, which corresponds to the user, undergoes a snapshot selection operation 208. Snapshot selection operation 208 performs selecting a user transaction at a snapshot time T. In an example, the snapshot time T is chosen randomly (or pseudo-randomly), so the user transaction is selected at a random snapshot time T can be referred to as a random transaction. In another example, the snapshot time T is manually or algorithmically selected. The snapshot time T can be a time that corresponds to an actual time of a transaction, or it can be a time not associated with a transaction.

Next, N transactions made by the user U relative to the snapshot time T are selected and stored in an N-transactions table 210 or another data structure. The N transactions can be N transactions prior to the snapshot time T. N transactions after the snapshot time T, or include at least some transactions before and after the snapshot time T. This selected data can serve as the input for transactional model 130. In some implementations, this selection process can be virtual. directly preparing the input to be fed to the transactional model 130 without physically storing the N-transactions table 210.

The selection of the N transactions may be accomplished, for example, (1) by defining a maximum number N or collected transactions or (2) by defining a number based on a number of transactions occurring within a time period (e.g., a maximum backward time T-Δ in which to collect transactions, where Δ is in hours, days, week, etc.), other ways, or a combination thereof.

In some embodiments, where the transactional model 130 is trained with a pair of sequences, a couple of snapshot times T1 and T2 may be selected for the user U, where N transactions and M transactions are related. In other embodiments, the model may be trained using N transactions that occurred before random snapshot time T and the M transactions occurred right after snapshot time T.

The resulting sequence of token encodings with time encodings can be used as training input to the transactional model (e.g., a neural network or other machine learning model), which can learn to make a prediction based on transactional event data, and particularly based on a transaction history up to snapshot time T. During training the prediction of the model can be compared with the output and the model can be updated using, for example, backpropagation.

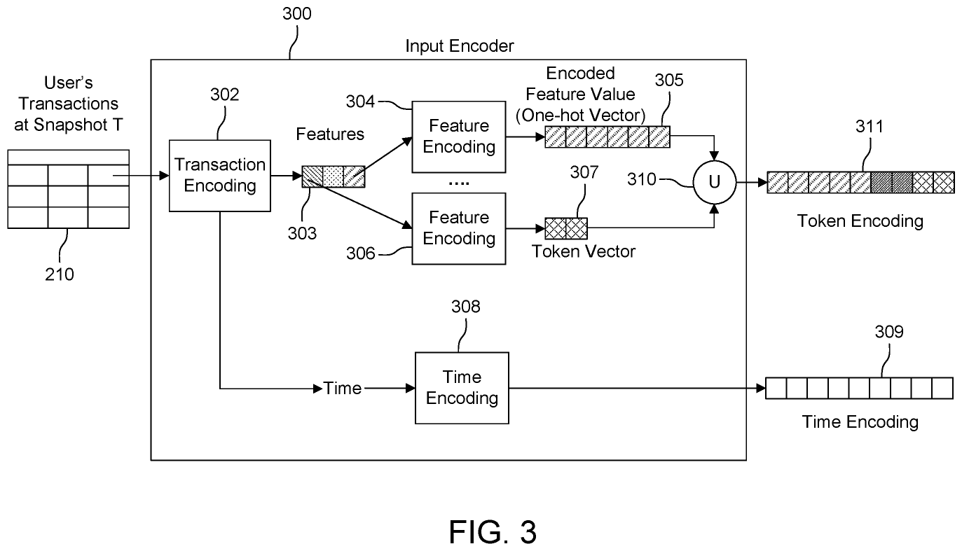

FIG. 3 illustrates an input encoder 300 for encoding each of a plurality of transactional events using token encoding and time encoding, according to an example embodiment. In some embodiments, the sequence of transactions for one user that is selected by snapshot selection operation 208 of FIG. 2 are applied to a transaction encoding operation 302 to encode certain features from N-transactions table 210 of FIG. 2 (also depicted in FIG. 3), by selecting features 303 of each transaction (e.g., certain columns of N-transactions table 210). Each feature is, in turn, feature encoded. In some embodiments, each feature is coded by a one-hot vector feature encoding operation 304 into a one-hot vector 305 and by a token feature encoding operation 306 into a token vector 307. In turn, the one-hot vector 305 and the token vector 307 are applied to a concatenation operation 310 to generate concatenations of the one-hot vector 305 and the token vector 307 (one per feature). The concatenations form a token encoding vector 311. A time encoding operation 308, in turn, operates to perform time encoding to generate a time encoding vector 309 by computing time (seconds, days, weeks, etc.) passed by the snapshot T and the actual time of the transaction. The token encoding vector 311 and the time encoding vector 309 are the input into the transactional model 130 of FIG. 1. The token encoding vector 311 and the time encoding vector 309 can be provided as training data to the transactional model.

### Masked Model Approach

In an example implementation, transactional model 130 is pre-trained in an unsupervised (e.g., self-supervised) way using a masked model approach, which is often referred to simply as masking. The transactional model 130 accepts as input a sequence of transactions, with some of the transactions masked, e.g., hidden from the model. Transactional model 130, in turn, is trained to “fill” the masked transactions with the real value.

In an example implementation, a sequence of transactions is obtained and some of the transactions, or parts of the transactions, are masked. In turn, the masked sequence of transactions is used to train the model to “fill” in the missing values. For example, suppose a sequence of transactions are represented as: A, B, C, D, E, F, G. Transactions D and E can be masked (e.g., randomly), so that the input to the transactional model 130 would be: A, B, C, [MASK], [MASK], F, G. The transactional model 130 would then be trained to predict the missing transactions or parts of transactions by using the context of the surrounding transactions.

In an example implementation, an entire selected transaction (e.g., its whole vector) can be masked. Alternatively, a subset of the vector of the selected transaction can be masked, for example, by masking one or more features (e.g., only the portion of vector related to the sub-one hot vector of the selected features), or also by masking the time encodings.

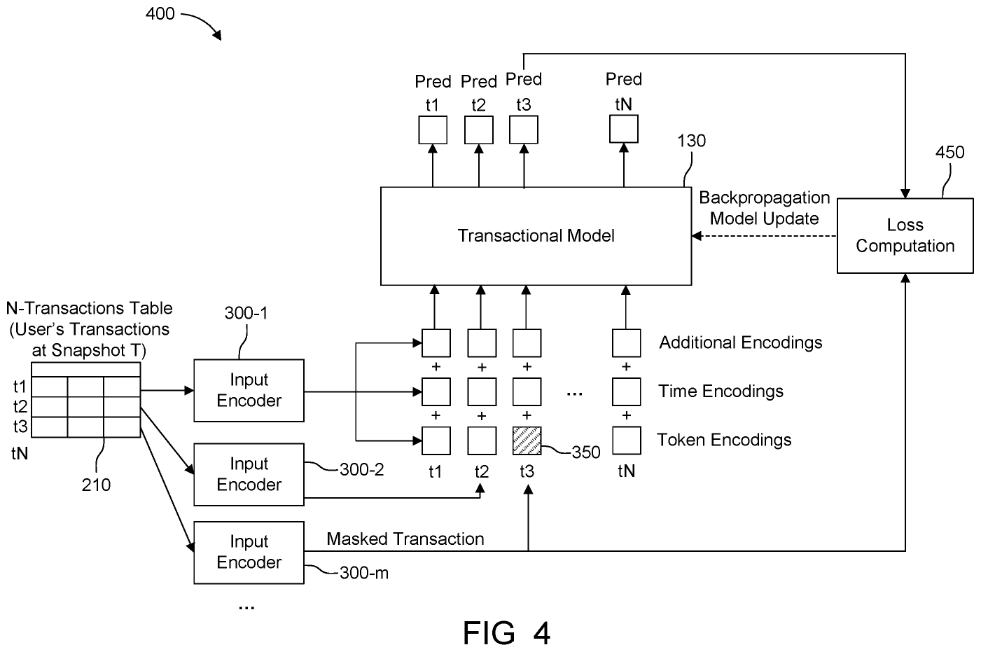

FIG. 4 illustrates a self-supervised process 400 for pre-training a transactional model using masking, according to an example embodiment. The pre-training process involves using a technique referred to herein as masked transaction modeling, where one or more transactions are selected (e.g., randomly) and masked in the input sequence. The transactional model 130 is then trained to predict the masked transactions based on the unmasked ones.

In an example embodiment, to initiate the pre-training process, an input sequence is first represented as a series of encodings of a plurality of transactions. The series of encodings are vector representations that form the input to the transactional model 130. In an example implementation, a plurality of transactions from N-transactions table 210, corresponding to a user U, are selected to be encoded by input encoder 300. For clarity, three instances of input encoder 300 are depicted (i.e., first instance of input encoder 300-1, second instance of input encoder 300-2, . . . , m-th instance of input encoder 300-m).

Each row selected from the N-transactions table 210 is input into an instance of input encoder 300. This step creates token encodings and time encodings for each transaction. The result is the selected individual transactional events organized as a series of encodings. The series of encodings can, in turn, be used as the time series input into the transactional model 130, enabling it to learn from the data.

As illustrated in FIG. 4, additional encodings may be determined from this transactional event data.

In the example implementation of FIG. 4, one of the transaction event encodings has been masked by a masking operation. In this example, a transaction event encoding 350 corresponding to transactional event t3 has been masked.

The masking operation can be performed in various ways. In an example implementation, the entire token encodings can be masked. In another example implementation only a portion of the token encodings, such as a subset of features or one-hot sub-vectors, can be masked.

Additionally, the time encodings can also be masked to provide temporal context for the transactional model 130.

Once the transactions are masked and input to the transactional model 130, the transactional model 130 is trained to decode and reconstruct the original input sequence using the unmasked transactions as context. Specifically, the transactional model 130 is trained to predict the masked transactions based on the context provided by the unmasked transactions. This process enables the transactional model 130 to learn the underlying patterns and dependencies in the input data, which can then be used for downstream tasks such as classification, prediction, or generation.

In turn, the N transactional event encodings are applied to the transactional model 130 to predict N predicted transactional events encodings as output (Pred t1, Pred t2, Pred t3, . . . , Pred tN)

The prediction of the transaction encoding that was masked (Pred t3) and the original transaction encoding that was masked (t3) are fed to a loss calculator 450. The loss calculator 450 operates to compute the loss between the predicted transaction encoding (Pred t3) and the original transaction encoding (t3) that was masked during the pre-training process. The loss is then fed into the transactional model 130 to update the transactional model 130 using a backpropagation operation. In an example, the backpropagation operation calculates the gradients of the error with respect to the weights of the network, which are then used to adjust the weights during training.

The pre-training process is self-supervised, meaning that it does not require any explicit labels or annotations for the input data. Instead, the transactional model 130 learns from the inherent structure of the data itself, using the masked transactions as a form of self-supervision. This makes the pre-training process more scalable and flexible, as it can be applied to a wide range of input data without the need for extensive manual labeling or annotation.

### Next Sequence Prediction Approach

Next Sequence Prediction is an unsupervised pre-training technique that involves predicting the next item in a sequence of data. This approach is used, in some embodiments, to pre-train the transactional model 130 by accepting as input a pair of sequences of transactions. A certain percentage of the inputs (e.g. 50%) may contain two sequences of transactions that were made by the same customer, while in others the second sequence may be a random sequence taken from the dataset. In an example use case, in half of the inputs, both sequences are chosen from the same customer, while in the other half, the second sequence is randomly chosen from the dataset.

The transactional model 130 is then trained to predict whether the two sequences are linked. If the sequences are from the same customer, then they are linked, and if they are not, then they are not linked. By training the transactional model to predict the link between the sequences, it learns to understand the patterns in the data and how transactions relate to each other.

This pre-training technique can be beneficial because it helps the model to learn the underlying patterns in the data without being explicitly told what those patterns are.

In such case, the transactional model 130 is trained to detect whether the two sequences are actually linked or not.

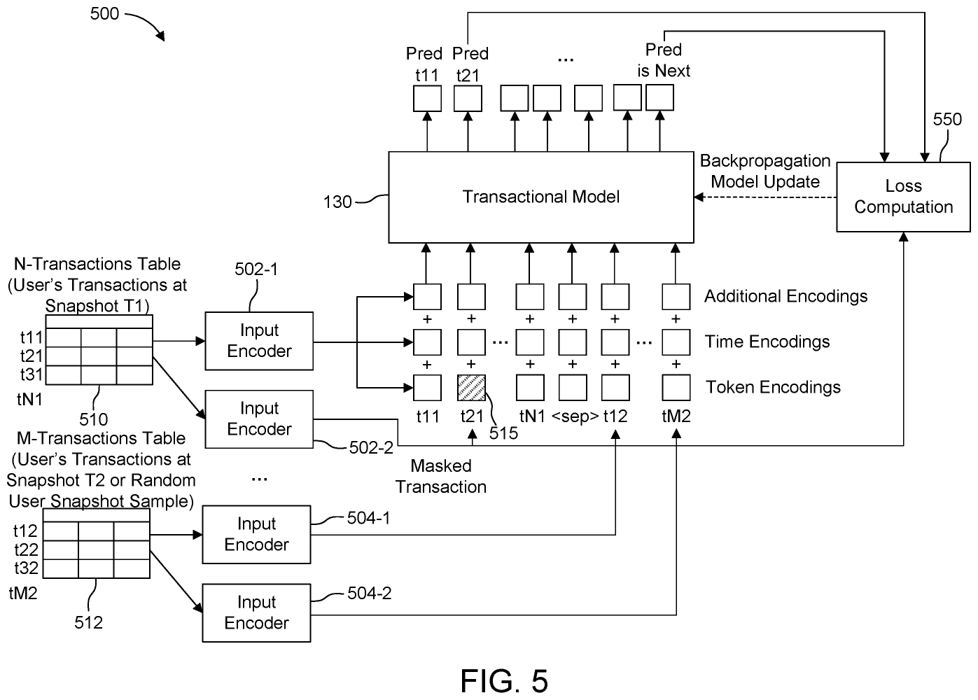

FIG. 5 illustrates a self-supervised architecture 500 for pre-training a transactional model that combines masked transaction modeling and next sequence prediction, according to an example embodiment. This approach can be used to pre-train the transactional model for various downstream tasks related to transactional event data analysis.

To begin the pre-training process, in this example embodiment, two transaction sequences (i.e., t11, t21, . . . , tN1 and t12, t22, . . . , tM2) are taken as inputs to the transactional model 130 in the form of encodings. These two transaction sequences can be from the same user. Alternatively, these two transactions can be taken from two different users. Whether the two transaction sequences are taken from the same user or from two different users can be selected based on a pre-training objective.

In this embodiment, an input sequence is first represented as a series of encodings of a plurality of transactions. The series of encodings are vector representations that form the input to the transactional model 130. In an example implementation, a plurality of transactions from a first transactions table 510 are selected to be encoded by a first input encoder 502. For clarity, two instances of first input encoder 502 are depicted (i.e., a first instance of first input encoder 502-1 and a second instance of first input encoder 502-2). Similarly, a plurality of transactions from a second transactions table 512 are selected to be encoded by a second input encoder 504. For clarity, two instances of the second input encoder 504 are depicted (i.e., a first instance of second input encoder 504-1 and second instance of second input encoder 504-2).

In some embodiments, first input encoder 502 and second input encoder 504 are the same encoder and thus all the instances of the input encoders are the same.

Each row selected from the first transactions table 510 is input into an instance of first input encoder 502. Each row selected from the second transactions table 512 is input into an instance of second input encoder 504. This step creates token encodings and time encodings for each transaction. The result is the selected individual transactional events organized as a series of encodings. The series of encodings can, in turn, be used as the time series input into the transactional model 130, enabling it to learn from the data.

In this example embodiment, a separator sequence <sep> is added to separate the first transaction sequence (t11, t12, . . . , tN1) from the second transaction sequence (t12, . . . , tM2). In an example implementation, additional encodings are used by the transactional model to separate the first transaction sequence and the second transaction sequence.

In an example implementation where the two transaction sequences are for the same user, transactional event data is obtained from a first transactions table 510 (e.g., depicted in FIG. 5 as an N-transactions table, where N is an integer) in a consecutive manner (e.g., consecutive transactional events for a first user within a first month) and transactional event data obtained for the same user from a second transactions table 512 (e.g., depicted in FIG. 5 as an M-transactions table, where M is an integer) in a consecutive manner (e.g. consecutive transactional events for the first user within a month after the first month).

In another example implementation where the two transaction sequences are for different users, transactional event data is obtained for a first user from a first transactions table 510 in a consecutive manner (e.g., consecutive transactional events for a first user within a month) and transactional event data obtained for a second user from a second transactions table 512 in a consecutive manner (e.g. consecutive transactional events for the second user within a second month, where the second month may or may not overlap with the first month).

This pre-training objective encourages the transactional model to learn the underlying patterns and dependencies in the transactional event data.

A masking training stage, as described in connection with FIG. 4, may also be performed during this pre-training process. This involves randomly masking one or more transactions in the input sequences and training the transactional model to predict the masked transactions based on the unmasked ones. This approach provides additional self-supervision to the pre-training process and helps the transactional model learn from the structure of the transactional event data.

In addition to the above pre-training objectives, the transactional model can also be trained to detect whether the two input sequences come from the same user or not. This is done by adding an additional output layer to the transactional model that classifies the input sequences as belonging to the same user or different users. This pre-training objective can help the transactional model learn to distinguish between different users based on their transactional behavior.

In addition to or instead of the above pre-training objectives, the transactional model can also be trained to detect which transaction does not belong with the others. This is done by adding an additional transaction randomly selected from another user, by replacing one transaction at random from another user, or generating a synthetic transaction and replacing or adding the synthetic transaction. This pre-training objective can help the transactional model learn to distinguish between authentic transactions and inauthentic transactions.

The prediction of the transaction encoding that was masked (Pred t21) and the transaction encoding that was masked (t21) 515 and the prediction of the next sequence (Pred is next) together with the corresponding next sequence in the input sequence are fed to a loss calculator 550 to compute the loss. The loss is then fed into the transactional model 130 to update the transactional model 130 using backpropagation. The loss can be composed by multiple functions, considering different prediction types. For example, an implementation can involve a cross-entropy loss for the next sequence prediction, summed to a cross-entropy loss for each masked categorical features, and further summed to a mean squared error loss for each masked numerical feature.

The self-supervised pre-training technique shown in FIG. 5 is flexible and can be adapted to various downstream tasks related to transactional event data analysis. By pre-training the transactional model using a combination of Masked Transaction Modeling, Next Sequence Prediction, and user classification, the transactional model can learn to capture the complex patterns and dependencies present in transactional event data and can be used for various applications.

### Prediction Task Approach

Another unsupervised way to pre-train the transactional model 130 involves prediction tasks. Generally, in this embodiment, a snapshot time T is defined, and the previous N transactions of a user (e.g., a customer) are used as input to the transactional model 130. The transactional model 130 is then trained to predict the next M transactions (where M>=1) or the transactions made in the next T+Δ time-period. The predicted output from the transactional model 130 is then used to train the transactional model 130 using backpropagation.

The prediction task involves training the transactional model to predict future transactions based on past transactional event data, which involves calculating and minimizing prediction errors.

The desired output of the transactional model 130 may be the number of transactions made in a fixed future time-period or an aggregation of one or more features of the future transactions, such as the sum of the dollar ($) amount of future transactions, the count of transactions, or the count of transactions made to a specific merchant category.

This pre-training approach can be useful because it allows the transactional model 130 to learn patterns and relationships between past and future transactions. It enables the model to identify patterns that are indicative of future transactions or spending behavior, and this information can be used for various tasks.

After pre-training the transactional model 130, the transactional model 130 can then be fine-tuned.

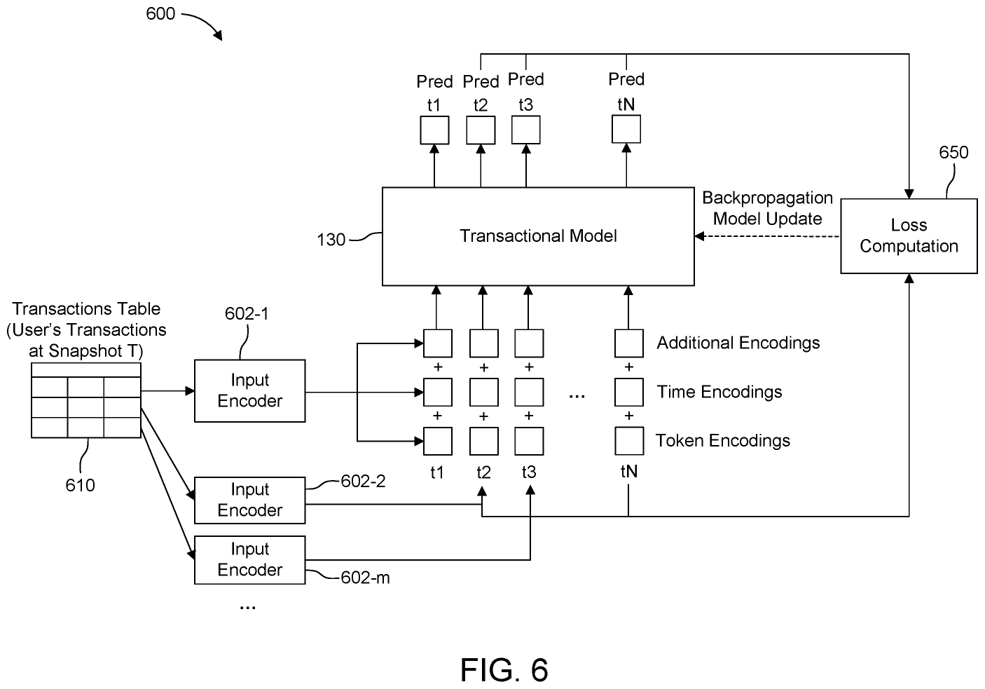

FIG. 6 illustrates a self-supervised architecture 600 for pre-training a transactional model, according to an example embodiment. This embodiment of the self-supervised architecture 600 predicts future transactions given a snapshot of the transactional event data at a particular time T. This approach can be particularly useful for pre-training an autoregressive transactional model for various downstream tasks related to transactional event data analysis.

In an example embodiment, to initiate the pre-training process, an input sequence is first represented as a series of encodings of a plurality of transactions. The series of encodings are vector representations that form the input to the transactional model 130. In an example implementation, a plurality of transactions from a transactions table 610 (e.g., N transactions, where N is an integer), corresponding to a user U, are selected to be encoded by input encoder 602. For clarity, three instances of input encoder 602 are depicted (i.e., first instance of input encoder 602-1, second instance of input encoder 602-2, . . . , mth instance of input encoder 602-m).

In turn, the transactional event encodings are applied to the transactional model 130 to predict a plurality (e.g., N) predicted transactional events encodings as output (Pred t1, Pred t2, Pred t3, . . . , Pred tN).

In this example embodiment, there are N indexes. A first transaction sequence (e.g., t1) is known and a prediction operation is performed to predict a second transaction sequence (Pred t2). A loss computation operation performed by a loss calculator 650 that computes the loss of the difference between the predicted second transaction sequence (Pred t2) and the real transaction sequence (t2). Then, knowing first transaction sequence t1 and the second transaction sequence (t2), transactional model predicts a third transaction sequence (Pred t3). Then, first transaction sequence (t1), the second transaction sequence (t2), and the third transaction sequence (t3) are used to predict a fourth transaction sequence (Pred t4; not shown), and so on until tN is predicted (Pred tN).

The prediction of the transaction encodings (Pred t1, Pred t2, Pred t3, . . . , Pred tN) and the original transaction encodings (t1, t2, t3, . . . , tN) are fed to a loss calculator 650. The loss calculator 650 operates to compute the loss between the predicted transaction encodings (Pred t1, Pred t2, Pred t3, . . . , Pred tN) and the original transaction encoding (t1, t2, t3, . . . , tN) during the pre-training process. The loss is then fed into the transactional model 130 to update the transactional model 130 using backpropagation.

In some embodiments, two transaction sequences are selected for a snapshot time T. The two sequences can be from the same user or from two different users, depending on the pre-training objective. For each sequence, the transactional model takes as input all transactions from the second transaction (transaction 2) up to the Nth transaction, and is trained to predict the N+1th transaction. In other words, the transactional model 130 can be trained to predict the next transaction in the sequence given the previous transactions as input.

This approach encourages the transactional model to learn the underlying patterns and dependencies in the transactional event data, which can help in predicting future transactions accurately. It also provides a form of self-supervision to the pre-training process, as the transactional model is trained to predict the correct next transaction based on the previous transactions in the sequence.

### Fine-Tuning

Fine-tuning is a technique that is used to adapt a pre-trained machine learning model to a specific task. In the case of a transactional model, fine-tuning can be done with a smaller dataset as compared to the dataset used to pre-train the transactional model. This is, because the transactional model has already learned general features from the pre-training dataset, and fine-tuning only requires it to learn the specific features relevant to the new use-case.

Different use-cases can be created for the transactional model based on the input data, which may be a sequence of transactions. To fine-tune the transactional model for a specific use-case, a minimal dataset can be used. For example, a use-case may be to predict future purchases, future payments or missing payments, fraud detection, attrition prediction, cash-flow forecasting, most purchased merchant or merchant category, and most high drop and/or increase in spending category, among others.

Each of these use-cases can be seen as a practical application of the transactional model, and the model can be fine-tuned to perform optimally for each use-case. By doing so, the transactional model can be adapted to specific needs and provide more accurate and useful predictions or insights based on the input data.

FIG. 7 illustrates a fine-tuning architecture 700 for fine-tuning a transactional model 130, according to an example embodiment. In some embodiments, the fine-tuning architecture 700 involves using the pre-trained transactional model 130 to solve a specific downstream task related to transactional event data analysis (e.g., fraud detection, transaction detection, etc.). In this case, the downstream task involves predicting the next M transactions made by a user after a snapshot time T, given their previous N transactions.

To fine-tune the pre-trained transactional model 130 for this task, two transaction sequences are selected for a snapshot time T: N transactions made by the user prior to time T 710 and M transactions made after time T 712. These two sequences are used as input to the transactional model 130 during the fine-tuning process using input encoders 702 (e.g., first instance of first input encoder 702-1, second instance of first input encoder 702-2; first instance of second input encoder 704-1, second instance of second input encoder 704-2). The transactional model 130 in this example embodiment is trained to predict the sequence of the next M transactions given the prior N transactions as input.

In an example implementation, input to the transactional model 130 corresponds to transactional event data for a first user corresponding to one month of transactional events. The output of the transactional model 130 is the predicted transactional events for the next month.

In turn, the real transactions made by the user and the predicted transactions of the user for the following month are applied to a loss computation operation 750 that computes the loss of the difference between the predicted transaction sequence and the real transaction sequence.

During fine-tuning, the transactional model 130 is, in an example implementation, trained using supervised learning techniques, where the ground truth labels are the actual M transactions made by the user after time T. This fine-tuning process allows the transactional model to adapt to the specific task of predicting future transactions based on a given snapshot of transactional event data.

An implementation of fine-tuning process involves the use of fraudulent transaction information. In this case, the model is fine-tuned to recognize fraudulent transactions. Using known information of fraudulent transactions, i.e., labels. An input of the model is constructed as sequence of transactions made by a customer, and the fraudulent labels are used to mark each transaction as legit or frauds. The model is fine-tuned to classify each transaction in the input as fraudulent or not.

In an example the fine tuning relies on transfer learning. For instance, the pre-trained transactional model 130 may perform somewhat well at related tasks for which it was not explicitly trained. Thus, the pre-training may speed up the fine tuning and allow for the fine-tuned model to produce better results faster and with less training data than it might otherwise. Fine tuning may make the fine-tuned model 126 suitable for use on an individual level (there may be substantially less training data available). For instance, the pre-trained transactional model 130 may be produced with training data from many different users and the fine tuning may be performed with training data from a subset of users (e.g., demographically similar users) or even a single user.

For training future purchases, the fine-tuned model 126 can be trained to determine what a user's next purchase will be given a sequence of prior transactions. The training data can include a target transaction and a sequence of transactions prior to the target transaction. The fine-tuned model 126 can be configured to predict the entirety of the target transaction or a portion of the data thereof (e.g., time, geographic location, etc.). The resulting model can be used for any of a variety of purposes, such as detecting fraud (e.g., if an actual target transaction is sufficiently different from the predicted transaction), suggesting a particular payment method to use (e.g., alerting the user that the system predicts that they're going to go to the gas station and to use a particular payment instrument that gives extra rewards for gas station purchase), suggesting a particular location to go to (e.g., predicting that the next transaction will be the user withdrawing money from an ATM and suggesting a nearby ATM to use), suggestion products to purchase (e.g., by sending advertising or coupons relating to the next predicted transaction), other uses, or combinations thereof.

The fine-tuned model can be trained to determine whether future payments will be made. For instance, the training or fine-tuning data can include data regarding payments made or missed.

The fine-tuned model can be trained to determine attrition (e.g., whether a user will cease using particular products or services). For instance, the training data can include data from attrition events and the transactions leading up to them. If a model predicts that a user will attrit with a sufficiently high likelihood, remediation can occur. For instance, the user can be targeted with education or other techniques to increase the likelihood that the user will not attrit.

The fine-tuned model can be trained to forecast cash-flow. For instance, future cash-flow can be determined based on current cash flow. The training data can include future cash flow based on current cash flow. The model can be used for any of a variety of purposes, such as improved business forecasting.

The fine-tuned model can be trained to predict most purchased merchants, merchant categories, most purchased products, most purchased product categories. Such a trained model can be used to improve business forecasting and for inventory management purposes. Such data or predictions can include or take into account most high drop and/or increase in spending category.

### Multiple Transaction Models

In some embodiments, the input data may be generated by transactions and/or events related to a targeted user. For example, transaction types may be monetary, such as purchases, payments, transfers, interests, etc., or non-monetary, such as contacting a call center, reporting a stolen card, a change (e.g., a change in marital status, a change of address, etc.), and the like.

In some embodiments, the input data is created as a sequence containing an aggregation of transactions of all transaction types and fed into a transactional model. In other embodiments, the transactions are divided into N types, such as monetary and non-monetary, and fed into the N different transactional models. The (N) outputs of the transactional models are, in turn, aggregated together by a predetermined method such as a voting system, a final machine learning model, or a final neural network layer.

When the aggregation method is a voting system, each transactional model outputs a prediction, and the final output is determined by taking the majority vote among the transactional models. When the aggregation method is a final machine learning model, such as random forest or linear regression, each transactional model is used to generate a set of features, and these features are then fed into the final machine learning model to produce the final output. When the aggregation method is a final neural network layer, the outputs of the transactional models are combined and fed into a neural network to provide the actual desired output.

Additional models, based on the aggregated information of a user, such as demographics, etc., that by nature are not sequential, may be fed to a machine learning model or a neural network and may be aggregated to the encoded input sequence. The aggregated new encoded values may then be used for the decoding or the classification phases.

Additional models may also be created by looking at different temporal aggregated information. As described above, the input of a transactional model may be a sequence of individual transactions, or a sequence of aggregated transactions occurred in a time period (e.g., a day, a week, a month, etc.). Some embodiments may provide several models that are trained on the same set of data, but in which the input of each model is aggregated by a different time period. For example, one model working on daily aggregation, one at week aggregation, etc. This may overcome the issue of the length of the input sequence for models with more fine-grained time aggregations (individual transactions or daily, for example) and using other models looking on more coarse-grained data (weekly or monthly, for example) to have a longer perspective of the users' behavior.

### Customer Data Use Case

In an example use case a transactional model 130 is pre-trained by using customer data that is available, such as demographic and behavioral information such as credit score (e.g., a FICO score), etc. This involves using the transactional event data to predict some aspects of the customer's profile.

The transactional model 130 can be trained to use the sequence of transactions as input and predict some user information or parts of it, such as the age or gender of the customer or their credit score. This technique can be used when only transactional event data is available, and other types of customer information are missing or incomplete.

By using the pre-training techniques described herein, the transactional model 130 can learn to recognize patterns in the transactional event data that are associated with certain customer characteristics. This can then be used to improve the transactional model's performance in various tasks. This technique can be beneficial because it allows the transactional model to learn from the available data without needing labeled data or explicit guidance on what to learn.

### System

FIG. 8 is a block diagram of a system 800 that can be used to implement one or more aspects described herein. As illustrated, the system 800 includes instructions 930, including those for training a transactional event data analysis model and fine-tuning a pre-trained model for predicting future transactions, according to the example embodiments described herein. In addition or instead, the instructions 930 can be for other purposes, such as to implement other aspects described herein.

The system 800 includes one or more processors (e.g., central processing units) 810, a main memory 825, and an interconnect bus 805. The main memory 825 stores, among other things, instructions and/or data for execution by the one or more processors 810. The main memory 825 may include non-transitory random-access memory, as well as non-transitory cache memory.

System 800 may further include a non-transitory mass storage device 830, peripheral device(s) 840, portable non-transitory storage medium device(s) 850, input device(s) 880, a graphics subsystem 860, and/or an output display 870. For explanatory purposes, all components in system 800 are shown in FIG. 8 as being coupled via the interconnect bus 805. However, the system is not so limited. Elements of system 800 may be coupled via one or more data transport means. For example, the one or more processors 810 and/or the main memory 825 may be coupled via a local microprocessor bus. The mass storage device 830, peripheral device(s) 840, portable storage medium device(s) 850, and/or graphics subsystem 860 may be coupled via one or more input/output buses. The mass storage device 830 may be a nonvolatile storage device for storing data and/or instructions 930 for execution by the one or more processors 810. The mass storage device 830 may be implemented, for example, with a solid-state storage device, a magnetic disk drive, an optical disk drive, or the like.

In a software embodiment, the mass storage device 830 is configured for loading contents of the mass storage device 830 into the main memory 825.

For example, mass storage device 830 can store instructions 930 which, when executed by one or more processors 810, cause the one or more processors 810 to act as a transaction selector 931, a mapper 932, a feature selector 933, an concatenator 934, a feature encoder 935, a time encoder 936, a token encoder 937, a masking component 938, a transactional model training and prediction system 939, a data analyzer 940, a quantizer 941, and a sequence selector 942.

Main memory 825 and mass storage device 830 are also referred to as data stores. Both the main memory 825 and the mass storage device 830 are used in the operation of the system for training the transactional model, and particularly operate as data stores that store and facilitate access to the necessary instructions and data during the training and prediction processes.

Mass storage device 830 can also store instructions 930, which when executed by the one or more processors, cause the one or more processors to perform the methods and operations described herein.

The portable storage medium device 850 operates in conjunction with a nonvolatile portable storage medium, such as, for example, flash memory, to input and output data and code to and from the system 800. In some embodiments, the software for storing information may be stored on a portable storage medium and may be input into the system 800 via the portable storage medium device 850. The peripheral device(s) 840 may include any type of computer support device, such as, for example, an input/output (I/O) interface configured to add additional functionality to the system 800. For example, the peripheral device(s) 840 may include a modem and/or a network interface card (wired or wireless) for interfacing the system 800 with a network 820, an infra-red communication device, BLUETOOTH device, cellular communication device, or the like.

The system 800 may include an optional graphics subsystem 860 and output display 870 to display textual and graphical information. Output display 870 may include a display such as a color super twisted nematic display, an in-plane switching liquid crystal display, a thin film transistor) display, a thin film diode display, an organic light-emitting diode display, an active matrix organic light-emitting diode display, and/or a liquid crystal display. The display can also be a touchscreen display, such as capacitive, resistive, infrared, or optical imaging-type touchscreen display.

The graphics subsystem 860 receives textual and graphical information and processes the information for output to the output display 870.

Input devices 880 can control the operation and various functions of system 800. Input devices 880 can include any components, circuitry, or logic operative to drive the functionality of system 800. For example, input device(s) 880 can include one or more processors acting under the control of an application.

In some embodiments, there is provided a system for training a transactional event data analysis model. The system comprises, a data store (e.g., mass storage device 830 or main memory 825), a transaction selector 931 and a mapper 932. The data store is configured to store transactional event data of a user in a transaction table, where transactional event data is asynchronous events sequences data (e.g., the events are not necessarily occurring at regular time intervals). The transaction selector 931 is configured to: randomly select a user transaction from the transaction table at a random snapshot time, and select transactional events made by user before the random snapshot time and store the transactional events in a transactions table. The mapper 932 is configured to map a transactional event timing position of each of the transactional events stored in the transactions table, where the transactional event timing position is represented using an integer index or a one-hot encoded vector.

In some embodiments, the transaction selector 931 is further configured to: select N transactional events by any one of (i) defining a maximum number of collected transactional events, (ii) defining a number based on a maximum backward time T-A during which transactional events were collected, or (iii) a combination of (i) and (ii).

In some embodiments, the system further comprises a feature selector 933, a feature encoder 935, a concatenator 934, a time encoder 936, and a token encoder 937. The feature selector 933 is configured to select a plurality of features of a plurality of transactional events stored in the N-transactions table. The feature encoder 935 is configured to: encode each feature into a one-hot vector, and encode each feature into a token vector. The concatenator 934 is configured to concatenate the one-hot vector and the token vector for each feature and generate concatenations of the one-hot vector and the token vector to form a token encoding vector. The time encoder 936 is configured to generate a time encoding vector by computing the time passed since the snapshot time T and the actual time of the transactional event. The token encoder 937 is configured to provide the token encoding vector and the time encoding vector as an input sequence into a transactional model.

In some embodiments, the transaction selector 931 is further configured to select (e.g., randomly) one or more transactional events to be masked in the input sequence to a transactional model. The system also comprises a masking component 938 configured to mask the selected transactional events by masking either (i) the entire token encodings, or (ii) a portion of the token encodings and produce masked transactional events. In this embodiment, the system also comprise a transactional model training and prediction system 939 is configured to: train the transactional model to decode and reconstruct the original input sequence using unmasked transactional events as context, predict the masked transactional events based on the context provided by the unmasked transactional events, and train the transactional model to learn underlying patterns and dependencies in the input data.

In some embodiments, the system comprises a transactional model training and prediction system 939 configured to: receive two transactional event sequences, train the transactional model to predict a next transactional event sequence using a predictive modeling algorithm for pre-training to learn patterns and dependencies based on the two transactional event sequences. In this embodiment, the masking component 938 is further configured to randomly mask one or more transactional events in the two transactional event sequences and train the transactional model to predict the masked transactional events based on the unmasked transactional events in the two transactional events sequences; and the transactional model training and prediction system 939 is further configured to add an additional output layer to the transactional model to classify query input sequences as belonging to the same users corresponding to the two transactional event sequences of different users.

In an example implementation, the transaction selector 931 is further configured to retrieve transactional events from the N-transactions table, wherein each of the transactional events contains F categorical features, where each feature is represented by a sub-vocabulary of Fn possible tokens. In this implementation, the system further comprises a feature encoder 935 configured to encode each categorical feature as a binary vector using a one-hot encoding scheme, where the binary vector has a length equal to the number of possible tokens in the sub-vocabulary; a concatenator 934 is configured to concatenate the binary vectors of each categorical feature to form a multi-hot vector for the transaction, where the size of the multi-hot vector is equal to the sum of the lengths of the binary vectors; and a data analyzer 940 is configured to input the multi-hot vector as a transactional event data input to a transactional model and perform data analysis on the transactional event data.

In some embodiments, the system further includes a quantizer 941 configured to: quantize numerical features of a transactional event obtained from the transactional table into a fixed number of bins, where each bin corresponds to a range of values, and each numerical value is assigned to one of the bins based on its magnitude; represent the quantized numerical features using one-hot vectors, where each vector has a size of n_{b}, which is the number of bins assigned to the numerical values after quantization. In this embodiment, the system further includes a concatenator 934 configured to concatenate the one-hot vectors of the quantized numerical features with the one-hot vectors of any categorical features to form multi-hot vectors; and a transactional model training and prediction system 939 configured to apply the multi-hot vectors as input to the transactional model for training and/or prediction.

In an example implementation, the system further comprises: a feature encoder 935 configured to: generate multi-hot vectors using a one-hot encoding scheme for categorical features of each transaction event obtained from the N-transactions table, wherein each categorical feature is represented as a binary vector having a length equal to the number of possible categories, and the binary vector is concatenated with other binary vectors to form each multi-hot vector, and represent numerical features of each transactional event using a one-hot encoding scheme, wherein each numerical feature is quantized into no bins and represented as a binary vector having a length equal to n_{b}, and the binary vector is concatenated with other binary vectors to form each multi-hot vector. The mapper 932 is further configured to map a transactional event timing position of each transactional event within a sequence of transactional events by mapping a transaction identifier to a corresponding transactional event timing position of the transaction within the sequence of transactions. In this embodiment, the system further comprises a transactional model training and prediction system 939 is configured to apply the generated multi-hot vectors and time encodings into a transactional model to generate a transactional model output.

In an example implementation, the transaction selector 931 is further configured to select a random set of transactional events that occurred at or before time T from the sequence of transactional events; and the feature encoder 935 is further configured to generate time encodings for each selected transactional event based on their distance in time of occurrence relative to time T.

In another embodiment described herein, a system for fine-tuning a pre-trained model for predicting future transactions is provided. The system includes a sequence selector 942 configured to select two sequences of N transactional events for a snapshot time T, wherein the N transactional events are real transaction events executed by a user prior to snapshot time T and M transactional events are M predicted transactional events executed after snapshot time T that are to be predicted; a transactional model training and prediction system 939 configured to: apply the selected two sequences of N transactional events as input to a transactional model, train the transactional model to predict the M predicted transactional events given the two sequences of N transactional events as input, apply the two sequences of N transactional events and the M predicted transactional events to a loss computer that computes a loss of the difference between the M predicted transactional events and the two sequences of N transactional events, and train the transactional model by applying the loss to a backpropagation algorithm.

A person of skill in the art, having benefit of this disclosure, may recognize various ways for implementing technology described herein. The person of skill in the art may use any of a variety of programming languages (e.g., a C-family programming language, PYTHON, JAVA, RUST, HASKELL, other languages, or combinations thereof) and libraries (e.g., libraries that provide functions for obtaining, processing, and presenting data). Example libraries include NLTK by Team NLTK (which provides natural language functionality), PYTORCH by META (which provides machine learning functionality), and NUMPY by the NUMPY Developers (which provides mathematical functions), among others. Operating systems (e.g., WINDOWS or LINUX based operating systems) may provide their own libraries or application programming interfaces useful for implementing aspects described herein. A person of skill in the art, with the benefit of the disclosure herein, can use programming tools to assist in the creation of software or hardware to achieve techniques described herein. Such tools can include intelligent code completion tools (e.g., INTELLISENSE), artificial intelligence tools (e.g., GITHUB COPILOT). Machine learning frameworks can be used to facilitate implementation of aspects described herein can be built or refined from existing frameworks, such as TENSORFLOW by GOOGLE, INC. or PYTORCH by the PYTORCH community.

Where implementations involve personal data, that personal data can be stored in a manner consistent with relevant laws and with a defined privacy policy. Where possible, the data can be anonymized or fuzzed to reduce the amount of accurate personal data that is unnecessarily stored. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions on the basis of protected characteristics.

The terminology used herein is for the purpose of describing particular examples only and is not intended to be limiting. As used herein, the singular forms “a”, “an” and “the” are intended to include the plural forms as well, unless the context clearly indicates otherwise.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

1. A method for training a transactional event data analysis model, comprising:
storing transactional event data of a user in a transaction table, where transactional event data is asynchronous events sequences data;
selecting a user transaction from the transaction table at a snapshot time;
selecting transactional events made by user relative to the snapshot time and storing the transactional events in a transactions table;
selecting a plurality of features of a plurality of transactional events stored in the transactions table and encoding each feature to form a token encoding;
mapping a transactional event timing position of each of the transactional events stored in the transactions table, thereby forming a time encoding, where the transactional event timing position is represented using an integer index or a one-hot encoded vector; and
providing the token encoding and the time encoding as an input sequence to train the transactional event data analysis model.

2. The method of claim 1,
wherein selecting the user transaction includes selecting the transaction at random;
wherein selecting the transactional events includes selecting transactional events made by the user before the snapshot time; and
wherein selecting the transactional events includes:
selecting a predetermined number of transactional events; or
selecting all transactional events occurring during a time period based on the random snapshot time.

3. The method according to claim 1, further comprising:
wherein encoding each feature includes:
encoding each feature into a one-hot vector, and
encoding each feature into a token vector;
wherein forming the token encoding includes concatenating the one-hot vector and the token vector for each feature, thereby generating concatenations of the one-hot vector and the token vector to form the token encoding; and
wherein forming the time encoding includes computing the time passed since the snapshot time and the actual time of the transactional event.

4. The method according to claim 1, further comprising:
selecting one or more transactional events to be masked in the input sequence to a transactional model;
masking the selected transactional events, wherein masking is applied to either (i) the entire token encodings, or (ii) a portion of the token encodings, thereby producing masked transactional events; and
wherein providing the token encoding and the time encoding as the input sequence includes:
training the transactional model to decode and reconstruct the original input sequence using unmasked transactional events as context;
predicting the masked transactional events based on the context provided by the unmasked transactional events; and
training the transactional model to learn underlying patterns and dependencies in the input data.

5. The method according to claim 1, further comprising:
receiving two transactional event sequences;
training the transactional model to predict a next transactional event sequence using a predictive modeling algorithm for pre-training to learn patterns and dependencies based on the two transactional event sequences;
performing a masking training stage by randomly masking one or more transactional events in the two transactional event sequences and training the transactional model to predict the masked transactional events based on the unmasked transactional events in the two transactional events sequences; and
adding an additional output layer to the transactional model to classify query input sequences as belonging to the same users corresponding to the two transactional event sequences of different users.

6. The method according to claim 1, further comprising:
retrieving transactional events from the transactions table, wherein each of the transactional events contains F categorical features, where each feature is represented by a sub-vocabulary of Fₙ possible tokens;
encoding each categorical feature as a binary vector using a one-hot encoding scheme, where the binary vector has a length equal to the number of possible tokens in the sub-vocabulary;
concatenating the binary vectors of each categorical feature to form a multi-hot vector for the transaction, where the size of the multi-hot vector is equal to the sum of the lengths of the binary vectors; and
inputting the multi-hot vector as a transactional event data input to a transactional model for analysis.

7. The method according to claim 1, further comprising:
quantizing numerical features of a transactional event obtained from the transactional table into a fixed number of bins, where each bin corresponds to a range of values, and each numerical value is assigned to one of the bins based on its magnitude;
representing the quantized numerical features using one-hot vectors, where each vector has a size of n_{b}, which is the number of bins assigned to the numerical values after quantization;
concatenating the one-hot vectors of the quantized numerical features with the one-hot vectors of any categorical features to form multi-hot vectors; and
using the multi-hot vectors as input to the transactional model for training and/or prediction.

8. The method according to claim 1, further comprising:
generating multi-hot vectors using a one-hot encoding scheme for categorical features of each transaction event obtained from the transactions table, wherein each categorical feature is represented as a binary vector having a length equal to the number of possible categories, and the binary vector is concatenated with other binary vectors to form each multi-hot vector;
representing numerical features of each transactional event using a one-hot encoding scheme, wherein each numerical feature is quantized into n_{b} bins and represented as a binary vector having a length equal to n_{b}, and the binary vector is concatenated with other binary vectors to form each multi-hot vector;
mapping a transactional event timing position of each transactional event within a sequence of transactional events by mapping a transaction identifier to a corresponding transactional event timing position of the transaction within the sequence of transactions; and
inputting the generated multi-hot vectors and time encodings into a transactional model to generate a transactional model output.

9. The method of claim 1, wherein the transactional event data analysis model is a first transactional event data analysis model of a group of transactional event data analysis models, the output of which is aggregated to produce a final output.

10. The method of claim 1, wherein the token encoding encodes at least one customer feature selected from the group consisting of: a demographic feature, a behavioral feature, and a credit score feature.

11. A system for training a transactional event data analysis model, comprising:
a data store configured to store transactional event data of a user in a transaction table, where transactional event data is asynchronous events sequences data;
a transaction selector configured to:
randomly select a user transaction from the transaction table at a random snapshot time, and
select transactional events made by user before the random snapshot time and store the transactional events in a transactions table; and
a mapper configured to map a transactional event timing position of each of the transactional events stored in the transactions table, where the transactional event timing position is represented using an integer index or a one-hot encoded vector.

12. The system of claim 11, wherein the transaction selector is further configured to select all transactional events within a time period.

13. The system according to claim 11, further comprising:
a feature selector configured to:
select a plurality of features of a plurality of transactional events stored in the transactions table;
a feature encoder configured to:
encode each feature into a one-hot vector, and
encode each feature into a token vector;
a concatenator configured to concatenate the one-hot vector and the token vector for each feature and generate concatenations of the one-hot vector and the token vector to form a token encoding vector;
a time encoder configured to generate a time encoding vector by computing the time passed since the snapshot time and the actual time of the transactional event; and
a token encoder providing the token encoding vector and the time encoding vector as an input sequence into a transactional model.

14. The system according to claim 13, further comprising:
the transaction selector further configured to select (e.g., randomly) one or more transactional events to be masked in the input sequence to a transactional model;
a masking component configured to mask the selected transactional events by masking either (i) the entire token encodings, or (ii) a portion of the token encodings and produce masked transactional events; and
a transactional model training and prediction system configured to:
train the transactional model to decode and reconstruct the original input sequence using unmasked transactional events as context,
predict the masked transactional events based on the context provided by the unmasked transactional events, and
train the transactional model to learn underlying patterns and dependencies in the input data.

15. The system according to claim 13, further comprising:
a transactional model training and prediction system configured to:
receive two transactional event sequences,
train the transactional model to predict a next transactional event sequence using a predictive modeling algorithm for pre-training to learn patterns and dependencies based on the two transactional event sequences;
the masking component further configured to randomly mask one or more transactional events in the two transactional event sequences and train the transactional model to predict the masked transactional events based on the unmasked transactional events in the two transactional events sequences; and
the transactional model training and prediction system further configured to add an additional output layer to the transactional model to classify query input sequences as belonging to the same users corresponding to the two transactional event sequences of different users.

16. The system according to claim 11, further comprising:
the transaction selector further configured to retrieve transactional events from the transactions table, wherein each of the transactional events contains F categorical features, where each feature is represented by a sub-vocabulary of Fₙ possible tokens;
a feature encoder configured to encode each categorical feature as a binary vector using a one-hot encoding scheme, where the binary vector has a length equal to the number of possible tokens in the sub-vocabulary;
a concatenator configured to concatenate the binary vectors of each categorical feature to form a multi-hot vector for the transaction, where the size of the multi-hot vector is equal to the sum of the lengths of the binary vectors; and
a data analyzer configured to input the multi-hot vector as a transactional event data input to a transactional model and perform data analysis on the transactional event data.

17. The system according to claim 11, further comprising:
a quantizer configured to:
quantize numerical features of a transactional event obtained from the transactional table into a fixed number of bins, where each bin corresponds to a range of values, and each numerical value is assigned to one of the bins based on its magnitude;
represent the quantized numerical features using one-hot vectors, where each vector has a size of n_{b}, which is the number of bins assigned to the numerical values after quantization;
a concatenator configured to concatenate the one-hot vectors of the quantized numerical features with the one-hot vectors of any categorical features to form multi-hot vectors; and
a transactional model training and prediction system configured to apply the multi-hot vectors as input to the transactional model for training and/or prediction.

18. The system according to claim 11, further comprising:
a feature encoder configured to:
generate multi-hot vectors using a one-hot encoding scheme for categorical features of each transaction event obtained from the N-transactions table, wherein each categorical feature is represented as a binary vector having a length equal to the number of possible categories, and the binary vector is concatenated with other binary vectors to form each multi-hot vector, and
represent numerical features of each transactional event using a one-hot encoding scheme, wherein each numerical feature is quantized into no bins and represented as a binary vector having a length equal to n_{b}, and the binary vector is concatenated with other binary vectors to form each multi-hot vector;
the mapper further configured to map a transactional event timing position of each transactional event within a sequence of transactional events by mapping a transaction identifier to a corresponding transactional event timing position of the transaction within the sequence of transactions; and
a transactional model training and prediction system configured to apply the generated multi-hot vectors and time encodings into a transactional model to generate a transactional model output.

19. The system of claim 18, wherein:
the transaction selector is further configured to select a random set of transactional events that occurred at or before a time from the sequence of transactional events; and
the feature encoder further configured to generate time encodings for each selected transactional event based on their distance in time of occurrence relative to the time.

20. A system for fine-tuning a pre-trained model for predicting future transactions, the system comprising:
a sequence selector configured to select two sequences of transactional events for a snapshot time, wherein the transactional events are real transaction events executed by a user prior to snapshot time and transactional events are predicted transactional events executed after snapshot time that are to be predicted; and
a transactional model training and prediction system configured to:
apply the selected two sequences of transactional events as input to a transactional model,
train the transactional model to predict the predicted transactional events given the two sequences of transactional events as input,
apply the two sequences of transactional events and the predicted transactional events to a loss computer that computes a loss of the difference between the predicted transactional events and the two sequences of transactional events, and
train the transactional model by applying the loss to a backpropagation algorithm.
